(19) United States
(12) Patent Application Publication
(10) Pub. No.: US 2010/0010810 A1
(43) Pub. Date: Jan. 14, 2010

(54) POST FILTER AND FILTERING METHOD

(75) Inventor: Toshiyuki Morii, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/518,741

(22) PCT Filed: Dec. 13, 2007
(86) PCT No.: PCT/JP2007/074044

§ 371 Date: Jun. 11, 2009

(30) Foreign Application Priority Data
Dec. 13, 2006 (JP) 2006-336271

(51) Int. Cl. G10L 11/04

(52) U.S. Cl. 704/207; 704/E11.006

(57) ABSTRACT

When a decoding audio signal is to be acquired by pitch-filtering a combined signal of a sub-frame length, a decoding audio signal is continuously changed at the boundary between sub-frames. The post filter includes: a first filter coefficient calculation unit (306) which obtains a pitch filter coefficient g_{P(0)} of a current frame so as to asymptotically approach the intensity g of the pitch filter from an initial value 0; a second filter coefficient calculation unit (307) which obtains a pitch filter coefficient g_{P(-1)} of a preceding frame so as to asymptotically approach 0 by setting the initial value to the value of the pitch filter coefficient obtained by the first filter coefficient calculation unit (306); a filter state setting unit (308) which sets a pitch filter state fsᵢ for each of the sub-frames; and a pitch filter (309) which pitch-filters the combined signal xᵢ by using the pitch filter coefficients g_{P(-1)}, g_{P(0)}, and past demodulation audio signals y_{i-P(-1)}, y_{i-P(0)}.

### TECHNICAL FIELD

The present invention relates to a post filter and filtering method that are used in a speech decoding apparatus which decodes an encoded speech signal.

### BACKGROUND ART

In mobile communication, it is necessary to compress and encode digital information such as speech and images to efficiently utilize radio channel capacity and a storing medium, and, therefore, many encoding/decoding schemes have been developed so far.

Among these techniques, performance of the speech coding technique has significantly improved thanks to the fundamental scheme “CELP (Code Excited Linear Prediction)” of ingeniously applying vector quantization by modeling the vocal tract system. Further, performance of a sound coding technique such as audio coding has improved significantly thanks to transform coding techniques (MPEG standard ACC, MP3 and the like).

Here, as processing subsequent to a decoder of a low bit rate, post-filtering is generally applied to synthesized sound before the synthesized sound is outputted. Almost all standard codecs for mobile telephones use this post filtering.

Post filtering for CELP uses a pole-zero type (i.e. ARMA type) pole emphasis filter using LPC parameters, high frequency band emphasis filter and pitch filter. Above all, the pitch filter is an important post filter that can reduce perceptual noise by further emphasizing the periodicity included in synthesized sound.

With Patent Document 1, a task is set assuming that a codec of a low bit rate performs compression encoding such as CELP on a per frame basis, and an algorithm of a comb filter (equivalent to a pitch filter) is disclosed for acquiring synthesized sound of good quality even in portions of transitioning characteristics where the characteristics of the pitch period or pitch periodicity change even in frames.
Patent Document 1: Japanese Patent Application Laid-Open No. 2001-147700

### DISCLOSURE OF INVENTION

### Problems to be Solved by the Invention

However, with conventional post filters, the pitch filter produces discontinuous changes at boundaries between subframes and, therefore, a decoded speech signal becomes discontinuous and there is a problem that sensation of annoying sound and degradation of sound quality occur.

In view of the above, it is therefore an object of the present invention to provide a post filter and filtering method for allowing a decoded speech signal to change continuously at boundaries between subframes when a decoded speech signal is acquired by applying a pitch filter to a syntheisized signal of a subframe length.

### Means for Solving the Problem

The post filter according to the present invention that applies pitch filtering to a signal of a subframe length at predetermined sampling timing intervals, employs a configuration including: a first filter coefficient calculating section that uses zero as an initial value and that calculates pitch filter coefficients of a current subframe on a per sample basis such that the pitch filter coefficients of the current subframe asymptotically approach a value that calculated in advance; a second filter coefficient calculating section that uses a value of the pitch filter coefficient calculated in the first filter coefficient calculating section as an initial value and that calculates pitch filter coefficients of a previous subframe on a per sample basis such that the pitch filter coefficients of the previous subframe asymptotically approach zero; and a filter operation section that applies pitch filtering to the signal on a per sample basis using the pitch filter coefficients of the previous subframe and the pitch filter coefficients of the current subframe.

The post filtering method according to the present invention for applying pitch filtering to a signal of a subframe length at predetermined sampling timing intervals, include: a first filter coefficient calculating step of using zero as an initial value and calculating pitch filter coefficients of a current subframe on a per sample basis such that the pitch filter coefficients of the current subframe asymptotically approach a value that calculated in advance; a second filter coefficient calculating step of using a value of the pitch filter coefficient calculated in the first filter coefficient calculating step as an initial value and calculating pitch filter coefficients of a previous subframe on a per sample basis such that the pitch filter coefficients of the previous subframe asymptotically approach zero; and a filter operation step of applying pitch filtering to the signal on a per sample basis using the pitch filter coefficients of the previous subframe and the pitch filter coefficients of the current subframe.

### ADVANTAGEOUS EFFECT OF THE INVENTION

According to the present invention, the filter using the pitch period of the current subframe is operated with the gradually increasing strength and a filter using the pitch period of the previous subframe is also used in parallel with the gradually attenuating strength, so that it is possible to realize a pitch filter that allows continuous changes at boundaries between subframes, and prevent sensation of annoying sound and degradation of sound quality from occurring.

### BRIEF DESCRIPTION OF DRAWINGS

FIG. 1 is a block diagram showing a configuration of a speech encoding apparatus that transmits encoded data to a speech decoding apparatus with a post filter according to an embodiment of the present invention;

FIG. 2 is a block diagram showing a configuration of the speech decoding apparatus with the post filter according to an embodiment of the present invention;

FIG. 3 is a block diagram showing an internal configuration of the post filter according to an embodiment of the present invention;

FIG. 4 is a flowchart explaining an algorithm of a pitch filter in the post filter according to an embodiment of the present invention; and

FIG. 5 shows an example of a change of pitch filter coefficients in case where a window function is used in the post filter according to an embodiment of the present invention.

### BEST MODE FOR CARRYING OUT THE INVENTION

An embodiment of the present invention will be explained below with reference to the accompanying drawings.

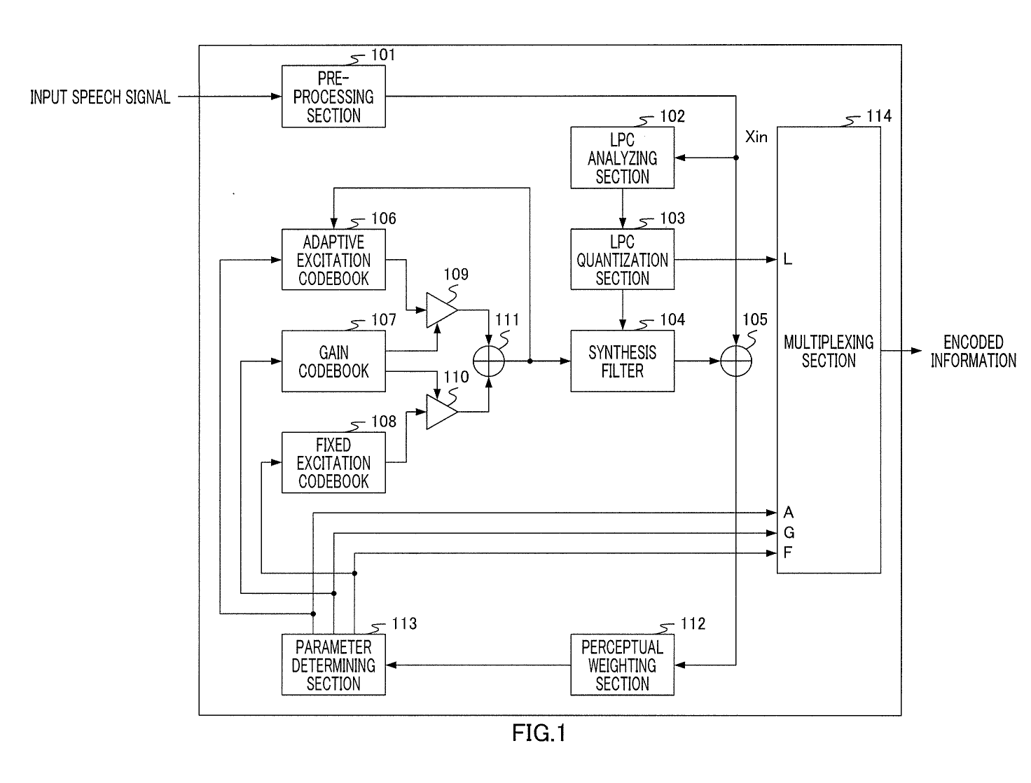

FIG. 1 is a block diagram showing a configuration of a speech encoding apparatus that transmits encoded data to a speech decoding apparatus with a post filter according to the present embodiment.

Pre-processing section 101 performs high pass filtering processing for removing the DC components and waveform shaping processing or pre-emphasis processing for improving the performance of subsequent encoding processing, with respect to an input speech signal, and outputs the signal (Xin) after these processings, to LPC analyzing section 102 and adding section 105.

LPC analyzing section 102 performs a linear prediction analysis using Xin, and outputs the analysis result (i.e. linear prediction coefficients) to LPC quantization section 103. LPC quantization section 103 carries out quantization processing of linear prediction coefficients (LPC's) outputted from LPC analyzing section 102, and outputs the quantized LPC's to synthesis filter 104 and a code (L) representing the quantized LPC's to multiplexing section 114.

Synthesis filter 104 carries out filter synthesis for an excitation outputted from adding section 111 (explained later) using filter coefficients based on the quantized LPC's, to generate a synthesized signal and output the synthesized signal to adding section 105.

Adding section 105 inverts the polarity of the synthesized signal and adds the signal to Xin to calculate an error signal, and outputs the error signal to perceptual weighting section 112.

Adaptive excitation codebook 106 stores past excitations outputted from adding section 111 in a buffer, clips one frame of samples from the past excitations as an adaptive excitation vector that is specified by a signal outputted from parameter determining section 113, and outputs the adaptive excitation vector to multiplying section 109.

Gain codebook 107 outputs the gain of the adaptive excitation vector that is specified by the signal outputted from parameter determining section 113 and the gain of a fixed excitation vector to multiplying section 109 and multiplying section 110, respectively.

Fixed excitation codebook 108 stores a plurality of pulse excitation vectors of a predetermined shape in a buffer, and outputs a fixed excitation vector acquired by multiplying by a dispersion vector a pulse excitation vector having a shape that is specified by the signal outputted from parameter determining section 113, to multiplying section 110.

Multiplying section 109 multiplies the adaptive excitation vector outputted from adaptive excitation codebook 106, by the gain outputted from gain codebook 107, and outputs the result to adding section 111. Multiplying section 110 multiplies the fixed excitation vector outputted from fixed excitation codebook 108, by the gain outputted from gain codebook 107, and outputs the result to adding section 111.

Adding section 111 receives as input the adaptive excitation vector and fixed excitation vector after gain multiplication, from multiplying section 109 and multiplying section 110, adds these vectors, and outputs an excitation representing the addition result to synthesis filter 104 and adaptive excitation codebook 106. Further, the excitation inputted to adaptive excitation codebook 106 is stored in a buffer.

Perceptual weighting section 112 applies perceptual weighting to the error signal outputted from adding section 105, and outputs the error signal to parameter determining section 113 as coding distortion.

Parameter determining section 113 searches for the codes for the adaptive excitation vector, fixed excitation vector and quantization gain that minimize the coding distortion outputted from perceptual weighting section 112, and outputs the searched code (A) representing the adaptive excitation vector, code (F) representing the fixed excitation vector and code (G) representing the quantization gain, to multiplexing section 114.

Multiplexing section 114 receives as input the code (L) representing the quantized LPC's from LPC quantizing section 103, receives as input the code (A) representing the adaptive excitation vector, the code (F) representing the fixed excitation vector and the code (G) representing the quantization gain from parameter determining section 113, and multiplexes these items of information to output encoded information.

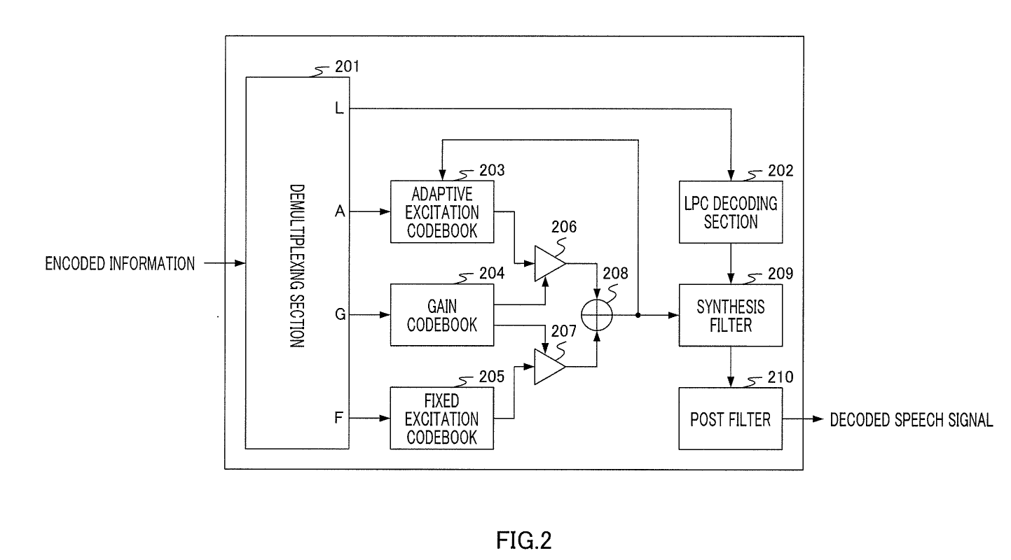

FIG. 2 is a block diagram showing a configuration of a speech decoding apparatus with a post filter according to the present embodiment. In FIG. 2, the encoded information is demultiplexed in demultiplexing section 201 into individual codes (L, A, G and F). The code (L) representing the quantized LPC's is outputted to LPC decoding section 202, the code (A) representing the adaptive excitation vector is outputted to adaptive excitation codebook 203, the code (G) representing the quantization gain is outputted to gain codebook 204 and the code (F) representing the fixed excitation vector is outputted to fixed excitation codebook 205.

LPC decoding section 202 decodes a quantized LSP parameter from the code (L) representing the quantized LPC'S, retransforms the resulting quantized LSP parameter to a quantized LPC parameter, and outputs the quantized LPC parameter to synthesis filter 209.

Adaptive excitation codebook 203 stores past excitations used in synthesis filter 209, extracts one frame of samples as an adaptive excitation vector from the past excitations that are specified by an adaptive excitation codebook lag associated with the code (A) representing the adaptive excitation vector and outputs the adaptive excitation vector to multiplying section 206. Further, adaptive excitation codebook 203 updates the stored excitations by means of the excitation outputted from adding section 208.

Gain codebook 204 decodes the gain of the adaptive excitation vector that is specified by the code (G) representing the quantization gain and the gain of the fixed excitation vector, and outputs the gain of the adaptive excitation vector and the gain of the fixed excitation vector to multiplying section 206 and multiplying section 207, respectively.

Fixed excitation codebook 205 stores a plurality of pulse excitation vectors of a predetermined shape in the buffer, generates a fixed excitation vector obtained by multiplying by a dispersion vector a pulse excitation vector having a shape that is specified by the code (F) representing the fixed excitation vector, and outputs the fixed excitation vector to multiplying section 207.

Multiplying section 206 multiplies the adaptive excitation vector by the gain and outputs the result to adding section 208. Multiplying section 207 multiplies the fixed excitation vector by the gain and outputs the result to adding section 208.

Adding section 208 adds the adaptive excitation vector and fixed excitation vector after gain multiplication outputted from multiplying sections 206 and 207 to generate an excitation, and outputs this excitation to synthesis filter 209 and adaptive excitation codebook 203.

Synthesis filter 209 carries out filter synthesis of the excitation outputted from adding section 208 using the filter coefficients decoded in LPC decoding section 202, and outputs the resulting signal (hereinafter “first synthesized signal”) and quantized LPC parameter to post filter 210.

Post filter 210 applies a pole emphasis filter to the first synthesized signal using the quantized LPC parameter. Further, post filter 210 acquires a decoded speech signal by performing a pitch analysis of the first synthesized signal, and applying pitch filtering to a synthesized signal (hereinafter referred to as “second synthesis signal”) to which pole emphasis filtering has been applied using the pitch period of the greatest correlation resulting from a pitch analysis and long term correlation coefficients.

Further, there may be cases where post filter 210 skips a pitch analysis to reduce the amount of calculation and applies filtering utilizing the adaptive excitation codebook lag and the gain of the adaptive excitation vector of adaptive excitation codebook 203.

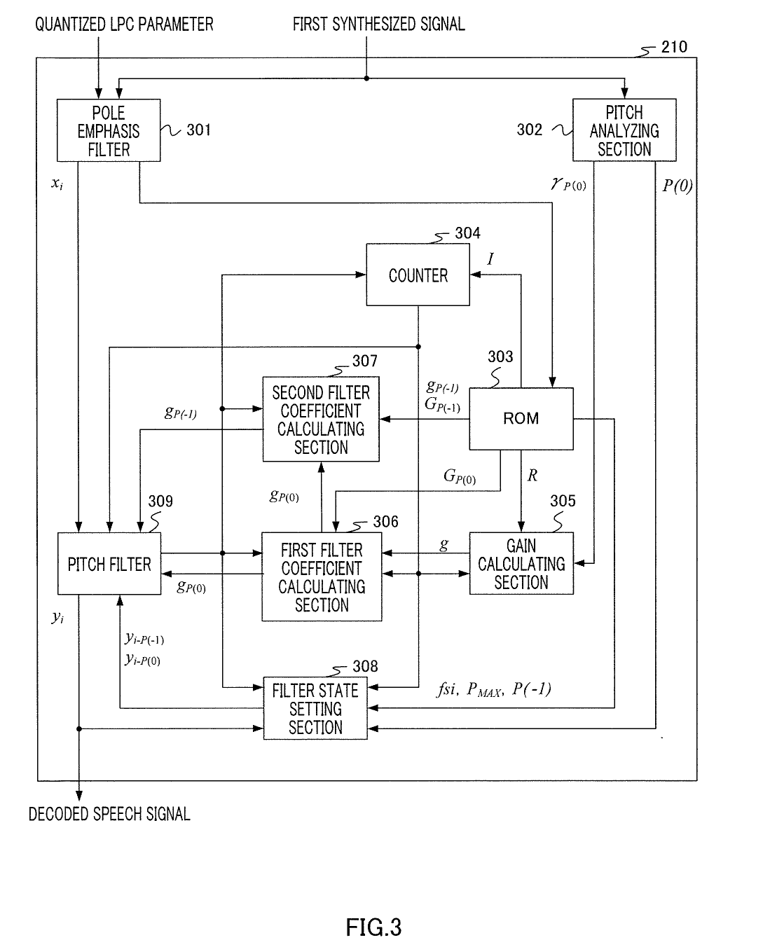

Next, the internal configuration of post filter 210 will be explained using the block diagram of FIG. 3. Further, values used in processing in each section of post filter 210 shown in FIG. 3 will be represented by the following symbols.
G_{P(-1)}, G_{P(0)}: the attenuation coefficients (the former is used for the previous subframe and the latter is used for the current subframe)
I: the subframe length
R: the strength coefficient
P_{MAX}: the maximum value of the pitch period
g_{P(-1)}, g_{P(0)}: the pitch filter coefficients (the former is used for the previous subframe and the latter is used for the current subframe)
P(−1), P(0): the pitch periods (the former is used for the previous subframe and the latter is used for the current subframe)
fsᵢ: the pitch filter state (i.e. past decoded speech signal)
xᵢ: the second synthesized signal
γ_{P(0)}: the long term correlation coefficient
i: the sample value
yᵢ: the decoded speech signal
g: the strength of the pitch filter

Post filter 210 has: pole emphasis filter 301; pitch analyzing section 302; ROM (Read Only Memory) 303; counter 304; gain calculating section 305; first filter coefficient calculating section 306; second filter coefficient calculating section 307; filter state setting section 308; and pitch filter 309.

Pole emphasis filter 301 applies pole emphasis filtering to the first synthesized signal using the quantized LPC parameter on a per subframe basis, and outputs the resulting second synthesized signal xᵢ to pitch filter 309. Further, pole emphasis filter 301 outputs a control signal indicating a start of a filter operation by pitch filter 309, to ROM 303.

Pitch analyzing section 302 performs a pitch analysis of the first synthesized signal on a per subframe basis, outputs the resulting pitch period P(0) of the greatest correlation to filter state setting section 308 and outputs the long term correlation coefficients γ_{P(0)}to gain calculating section 305.

ROM 303 stores attenuation coefficients G_{P(-1)} and G_{P(0)}, the subframe length I, strength coefficients R, the maximum value P_{MAX} of the pitch period, the initial values of pitch filter coefficients g_{P(-1)}, the initial value of the pitch period P(−1) and the initial value of the pitch filter state fsᵢ. Then, when receiving as input the control signal from pole emphasis filter 301, ROM 303 outputs the attenuation coefficients G_{P(-1)} and the initial values of the pitch filter coefficients g_{P(-1)} to second filter coefficient calculating section 307, the attenuation coefficients G_{P(0)} to first filter coefficient calculating section 306, the subframe length I to counter 304, the strength coefficients R to gain calculating section 305, the maximum value P_{MAX} of the pitch period, the initial value of the pitch period P(−1) and the initial value of the pitch filter state fsᵢ to filter state setting section 308.

Every time counter 304 receives as input the control signal from pitch filter 309 indicating the end of the filter operation for each sample, counter 304 increments the sample value i. Then, when the sample value i becomes equal to the subframe length I, counter 304 resets the sample value i and outputs a control signal indicating the end of the filter operation of each subframe, to gain calculating section 305, first filter coefficient calculating section 306, filter state setting section 308 and pitch filter 309.

Gain calculating section 305 finds the strength g of the pitch filter according to following equation 1 using the long term correlation coefficients γ_{P(0)} and the strength coefficients R on a per subframe basis, and outputs the strength g of the pitch filter to first filter coefficient calculating section 306. Further, when the long term correlation coefficients γ_{P(0)} are equal to or greater than 1.0, the strength g of the pitch filter is set to a value equaling the strength coefficients R and, when the long term correlation coefficients γ_{P(0)} are equal to or less than 0.0, the strength g of the pitch filter is set to zero. This is clipping for not taking an extreme value.

g=γ_{P(0)}×R

where,

when γ_{P(0)}≧1.0, g=R,

and

when γ_{P(0)}≦0.0, g=0 (Equation 1)

First filter coefficient calculating section 306 finds the pitch filter coefficients g_{P(0)} of each current sample according to following equation 2 using the attenuation coefficients G_{P(0)}, pitch filter coefficients g_{P(0)} of the previous sample and strength g of the pitch filter, and outputs the pitch filter coefficients g_{P(0)} to pitch filter 309. By repeating following equation 2, the pitch filter coefficients g_{P(0)} asymptotically approach the strength g of a pitch filter that calculated in advance. Further, when the filter operation for one subframe is finished, first filter coefficient calculating section 306 outputs pitch filter coefficients g_{P(0)} to second filter coefficient calculating section 307 and initializes the pitch filter coefficients g_{P(0)} held by first filter coefficient calculating section 306.

g_{P(0)}=g_{P(0)}×G_{P(0)}+g×(1−G_{P(0)}) (Equation 2)

Second filter coefficient calculating section 307 finds the pitch filter coefficients g_{P(-1)} of each current sample according following equation 3 using the attenuation coefficients G_{P(-1)} and the pitch filter coefficients g_{P(-1)} of the previous sample, and outputs the pitch filter coefficients g_{P(-1)} to pitch filter 309. By repeating following equation 3, the pitch filter coefficients g_{P(-1)} asymptotically approach 0. Further, second filter coefficient calculating section 307 receives as input the pitch filter coefficients g_{P(0)} from first filter coefficient calculating section 306 and uses these as new pitch filter coefficients g_{P(-1)}.

g_{P(-1)}=g_{P(-1)}×G_{P(-1)} (Equation 3)

Filter state setting section 308 sets the pitch filter state fsᵢ on a per subframe basis using the initial value of the pitch filter state fsᵢ or a decoded speech signal yᵢ resulting from pitch filtering in the past, and outputs the decoded speech signal y_{i-P(-1)} of P(−1) samples before the current sample and the decoded speech signal y_{i-P(0)} of P(0) samples before the current sample, to pitch filter 309. Further, filter state setting section 308 receives as input the decoded speech signal yᵢ from pitch filter 309 on a per sample basis, updates the filter state when the filter operation for one subframe is finished and uses the pitch period P(0) as a new pitch period P(−1).

Pitch filter 309 acquires the decoded speech signal yᵢ by executing the filter operation of applying pitch filtering to the second synthesized signal xᵢ according to following equation 4 using the pitch filter coefficients g_{P(-1)} and g_{P(0)} and past decoded speech signals yᵢ₋ₚ₍₋₁₎ and y_{i-P(0)}. Further, pitch filter 309 outputs the control signal indicating the end of the filter operation, to counter 304, first filter coefficient calculating section 306, second filter coefficient calculating section 307 and filter state setting section 308. When the filter operation for one subframe is finished, pitch filter 309 executes the filter operation for the second synthesized signal xᵢ of the next subframe.

yᵢ=xᵢ+g_{P(-1 )}×y_{i-P(-1)}+g_{P(0)}×y_{i-P(0)} (Equation 4)

According to the present embodiment, there is a term of g_{P(-1)}×y_{i-P(-1)} in the filter operation, so that it is possible to allow the decoded speech signal yᵢ change continuously at boundaries between subframes. Further, every time the filter operation is executed on a sample, the term of g_{P(-1)}×y_{i-P(-1)} gradually converges to 0.

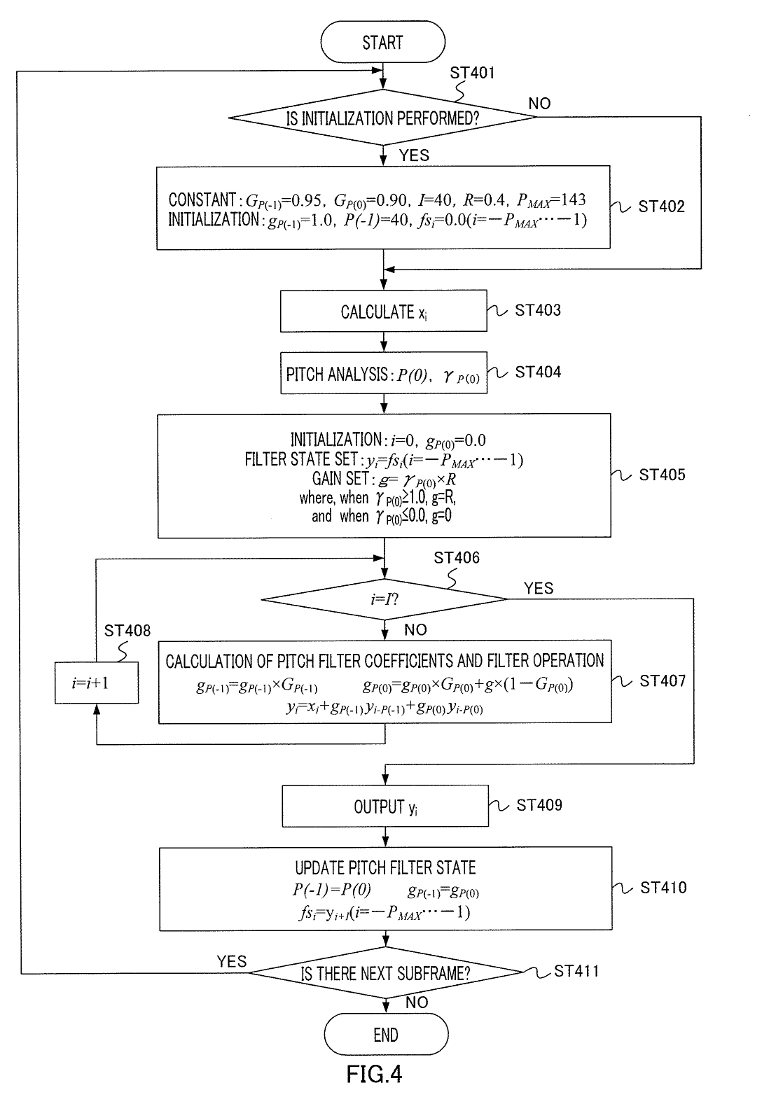

Next, the algorithm of post filter 210 according to the present embodiment will be explained using FIG. 4. Further, in FIG. 4, numerical values of constants stored in ROM 303 are set assuming that the sampling rate is 8 kHz and the subframe length is 5 ms, which are the units used in general low bit rate codecs for telephones.

ROM 303 stores in advance constants of post filter 210 (i.e. the attenuation coefficients G_{P(-1)} and G_{P(0)}, subframe length I, strength coefficients R and maximum value P_{MAX} of the pitch period) and the initial values of parameters and alignments of pitch filter coefficients g_{P(-1)}, the pitch period P(−1) and the pitch filter state fsᵢ.

First, before activating pitch filter 309, the parameters and alignments are initialized (ST 401 and ST 402).

Next, pole emphasis filter 301 calculates the second synthesized signal xᵢ (ST 403), and pitch analyzing section 302 performs a pitch analysis to acquire the pitch period P(0) of the greatest correction and long term correction coefficients γ_{P(0)} (ST 404).

Next, the sample value i of counter 304 and the pitch filter coefficients g_{P(0)} of the current frame of first filter coefficient calculating section 306 are initialized. Further, filter state setting section 308 substitutes the pitch filter state fsᵢ for the past pitch filter state fsᵢ in the area of alignments of decoded speech signals yᵢ. Further, gain calculating section 305 calculates the strength g of the pitch filter of the current subframe (ST 405).

Next, first filter coefficient calculating section 306 and second filter coefficient calculating section 307 calculate pitch filter coefficients g_{P(-1)} and g_{P(0)} on a per sample basis, and pitch filter 309 applies pitch filtering using two pitch periods, to the second synthesized signal xᵢ using both pitch filter coefficients g_{P(-1)} and g_{P(0)} (ST 406, ST 407 and ST 408). Further, pitch filter 309 of the present embodiment is an AR filter and so recursively uses the result of the filter operation as is.

When processing in ST 407 is carried out over one subframe and counter 304 detects the end of the subframe (ST 406: YES), the resulting decoded speech signal yᵢ is outputted (ST 409) and the states are updated for filtering the next subframe. To be more specific, the pitch period P(0) is stored in filter state setting section 308 as the pitch period P(−1) of the next subframe, the pitch filter coefficients g_{P(0)} are stored in second filter coefficient calculating section 307 as the pitch filter coefficients g_{P(-1)} of the next subframe and the past portion before the subframe length of the decoded speech signal yᵢ is stored as the pitch filter state fsᵢ of the next subframe is stored (ST 410 and ST 411).

In this way, according to the present embodiment, a filter using the pitch period of the current subframe is operated with the gradually increasing strength and a filter using the pitch period of the previous subframe is also used in parallel with the gradually attenuating strength, so that it is possible to realize a pitch filter that allows continuous changes at boundaries between subframes, and prevent sensation of annoying sound and degradation of sound quality from occuring.

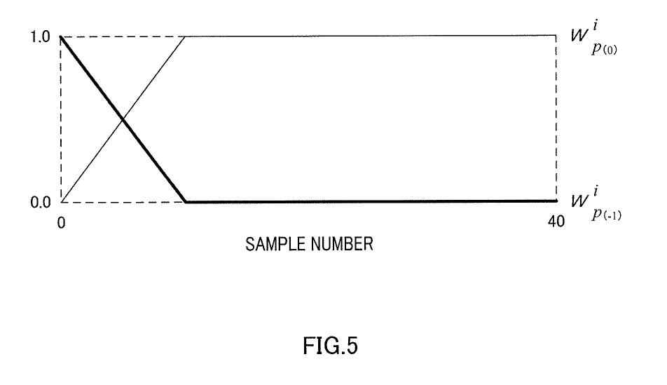

Further, although pitch filter coefficients are changed on a per sample basis by multiplying the pitch filter coefficients by constants with the present embodiment, the present invention is not limited to this and it is possible to provide the same advantage using the window function. In this case, filtering may be performed as in following equation 5 by providing in advance alignments Wⁱ_{P(-1)} and Wⁱ_{P(0)} having overlapping characteristics as in FIG. 5 without the operation using attenuation coefficients. However, in this case, g_{P(-1)} is updated by storing g.

yᵢ=xᵢ+Wⁱ_{P(-1)}×g_{P(-1)}×y_{i-P(-1)}+Wⁱ_{P(0)}×g_{P(0)}×y_{i-P(0)} (Equation 5)

Further, although a case has been explained with the present embodiment where the pitch period P(0) and long term prediction coefficients γ_{P(0)} are determined by a pitch analysis, the present invention is not limited to this, and the same advantage can be provided even by replacing these two values with the lag of adaptive excitation codebook 203 and the gain of the adaptive excitation vector. In this case, although the gain of the fixed excitation vector is encoded, thereby calculating the gain of the adaptive excitation vector and does not have to do with the long term prediction coefficients, the replacement of the pitch period and long term prediction coefficients provides an advantage of eliminating the amount of calculation for a pitch analysis. Further, there is also a method for using a lag of the adaptive excitation codebook as is as a pitch and finding only the long term prediction coefficients again. According to this method, it is possible to cancel the influence of the gain of the fixed excitation vector and realize a more accurate pitch filter.

Further, although constants are set assuming that the sampling frequency is 8 kHz and the subframe length is 5 ms, the present invention is also effective when other sampling frequencies and subframe lengths are used. By the way, it is confirmed that good performance can be achieved by setting the attenuation coefficients (i.e. constants) to values between 0.95 and 0.97 when a wideband codec (7 kHz frequency band and 16 kHz sampling rate) used in recent years is used.

Further, although the pitch filter is an AR filter with the present embodiment, the present invention can be implemented likewise even if the pitch filter is an MA filter. Even an MA filter can realize the pitch filter according to the present invention by storing the pitch filter state in the algorithm flowchart of FIG. 4 in the past portion of the second synthesized signal xᵢ, adapting calculation of pitch filter coefficients and the filter operation of the portion of the filter operation to the MA filter and, when the filter state is updated after filtering, storing the past portion before the subframe length of the second synthesized signal xᵢ as the filter state.

Further, although a fixed excitation vector is generated by multiplying a pulse excitation vector by a dispersion vector in a fixed excitation codebook with the present embodiment, the present invention is not limited to this and the pulse excitation vector itself may be used as the fixed excitation vector.

Further, although a case has been explained with the present embodiment where the present invention is used for CELP, the present invention is not limited to this and is also effective for other codecs. This is because post filtering is processing subsequent to decoder processing and does not depend on types of codecs.

Further, signals according to the present invention may be not only speech signals but also audio signals.

Furthermore, the speech decoding apparatus with the post filter according to the present invention can be provided in a communication terminal apparatus and base station apparatus in a mobile communication system, so that it is possible to provide a communication terminal apparatus, base station apparatus and mobile communication system having the same operations and advantages as explained above.

Also, although cases have been explained here as examples where the present invention is configured by hardware, the present invention can also be realized by software. For example, it is possible to implement the same functions as in the base station apparatus according to the present invention by describing algorithms according to the present invention using the programming language, and executing this program with an information processing section by storing this program in the memory.

Each function block employed in the explanation of each of the aforementioned embodiment may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if the integrated circuit technology comes out to replace LSI's as a result of the advancement of semiconductor technology or a derivative other technology, it is also naturally possible to carry out function block integration using this technology. Application of biotechnology is also possible.

The disclosure of Japanese Patent Application No. 2006-336271, filed on Dec. 13, 2006, including the specification, drawings and abstract, is incorporated herein by reference in its entirety.

### INDUSTRIAL APPLICABILITY

The present invention is suitable for use in a speech decoding apparatus and the like for decoding an encoded speech signal.

1. A post filter that applies pitch filtering to a signal of a subframe length at predetermined sampling timing intervals, the post filter comprising:
a first filter coefficient calculating section that uses zero as an initial value and that calculates pitch filter coefficients of a current subframe on a per sample basis such that the pitch filter coefficients of the current subframe asymptotically approach a value that calculated in advance;
a second filter coefficient calculating section that uses a value of the pitch filter coefficient calculated in the first filter coefficient calculating section as an initial value and that calculates pitch filter coefficients of a previous subframe on a per sample basis such that the pitch filter coefficients of the previous subframe asymptotically approach zero; and
a filter operation section that applies pitch filtering to the signal on a per sample basis using the pitch filter coefficients of the previous subframe and the pitch filter coefficients of the current subframe.

2. The post filter according to claim 1, wherein:
the first filter coefficient calculating section increases the pitch filter coefficients of the current subframe by multiplying the pitch filter coefficients of the current subframe by weighting parameters on a per sample basis; and
the second filter coefficient calculating section attenuates the pitch filter coefficients of the previous subframe by multiplying the pitch filter coefficients of the previous subframe by weighting parameters on a per sample basis.

3. A speech decoding apparatus comprising a post filter according to claim 1.

4. A post filtering method for applying pitch filtering to a signal of a subframe length at predetermined sampling timing intervals, the post filtering method comprising:
a first filter coefficient calculating step of using zero as an initial value and calculating pitch filter coefficients of a current subframe on a per sample basis such that the pitch filter coefficients of the current subframe asymptotically approach a value that calculated in advance;
a second filter coefficient calculating step of using a value of the pitch filter coefficient calculated in the first filter coefficient calculating step as an initial value and calculating pitch filter coefficients of a previous subframe on a per sample basis such that the pitch filter coefficients of the previous subframe asymptotically approach zero; and
a filter operation step of applying pitch filtering to the signal on a per sample basis using the pitch filter coefficients of the previous subframe and the pitch filter coefficients of the current subframe.
